(19) United States
(12) Patent Application Publication
(10) Pub. No.: US 2016/0121387 A1
(43) Pub. Date: May 5, 2016

(54) PROCESSES OF MAKING EXHAUST FLANGES AND USE OF THE FLANGES THEREOF

(71) Applicant: Kailash C. Vasudeva, Waterloo (CA)

(72) Inventor: Kailash C. Vasudeva, Waterloo (CA)

(21) Appl. No.: 14/930,449

(22) Filed: Nov. 2, 2015

Related U.S. Application Data
(60) Provisional application No. 62/073,544, filed on Oct. 31, 2014.
(60) Provisional application No. 62/137,571, filed on Mar. 24, 2015.

(51) Int. Cl. B21H 8/00; F01N 13/18; F16L 23/00; B21B 27/00; B21B 45/00; F01N 3/20; B21B 1/22

(52) U.S. Cl. CPC B21H 8/005; F01N 3/20; F01N 13/18; B21B 1/22; B21B 27/005; B21B 45/004; F16L 23/00; B21B 2001/225

(57) ABSTRACT

A flange making process, includes synchronized press to process the hot sheet metal right coming out of hot rolling mill. The hot rolling mill could have impression forms for pressing flange forms on hot metal sheet. This process could eliminate the consume of steel and energy. The flange could have a protrusion around the central hole. With this protrusion, it can move weld away from sealing surface and decrease deforming and leakage of the interface. The flange could be used on a flange assembly, wherein one of the pipe is extended to another pipe. It can improve the sealing the joint of the flange assembly.

### REFERENCE TO RELATED APPLICATION

This is a formal application based on, and claiming the benefit of, U.S. provisional patent application No. 62/073,544, filed on Oct. 31, 2014 and U.S. provisional patent application No. 62/137,571, filed on Mar. 24, 2015.

### BACKGROUND OF THE INVENTION

This invention relates generally to a flange and flange assembly, more particularly mainly to an exhaust flange and exhaust flange assembly used on exhaust systems of internal combustion engines, such as those used in automobiles and trucks.

In the field of exhaust systems, exhaust flanges are generally used to connect the ends of exhaust pipes to each other. In such systems, it is common to have stamped or forged and/or machined flanges which are welded to the ends of exhaust pipes and the flanges are to be joined to each other, with the flanges having flat mating surfaces which are bolted together with a gasket in between.

The current major processes for making exhaust flanges and the like are as below:

a) Stamping the flange out of rolled sheet metal followed by finish machining;

b) Hot forging followed by finish machining;

c) Powder metal forming and sintering;

However, there are various limitations/shortcomings of those processes as follows:

Stamped flanges are susceptible to leaks, as the current welding process introduces severe stresses that affect the flatness of the sealing surfaces. This phenomenon may only occur anytime during the use of the vehicle, as the exposure to high and low temperatures will promote stress releasing. As one of the reasons for the creation of leaks in an exhaust joint is corrosion, and considering the up-coming changes to the EPA legislation, it is imperative that the material used is suitable for the conditions, subsequently a higher grade of Stainless Steel.

The basic raw material being coiled sheet metal, already has inherent costs like transportation, warehousing, mark ups and margins etc. On top of that the equipment cost and process cost of straightening coil will be added in addition to actual manufacturing cost. Because of the scraps out of the stamping process, it causes the waste of material and increases the material cost.

For hot forged flanges, the raw material is rolled bar stock. This material also has inherent costs like transportation, warehousing, mark ups, margins etc. On top of that the equipment cost and process cost of cutting blanks for heating and feeding into dies will be added in addition to actual manufacturing cost.

The powder metal flanges are very expensive to make as the technology and the process has very high costs. Powder Metal parts are vulnerable to porosity.

In view of the preceding, it would therefore be advantageous to provide a flange and a flange assembly that can overcome above problem to decrease the cost and prolong the lifetime of the flange.

### BRIEF SUMMARY OF THE INVENTION

It is therefore an object of the invention to provide a process of making an exhaust flange right carried out in the steel mill; which can eliminate waste material and at the same time obtaining an improved production by the use of the method.

Another object of the invention is to provide a process of making exhaust flange by fine blanking process. The flange has a protrusion on the rear face around the central hole. With this protrusion, it can moving weld away from sealing surface and decreasing deforming and leakage of the flange mating surface.

Another object of the invention is to provide a method of using the flange made by above process, namely a flange joint assembly with the flange made by fine blanking process is provided. The joint assembly can overcome the drawback of the fine blanked flange.

Further details of the invention will be described or will become apparent in the course of the following detailed description and drawings of specific embodiments of the invention, as examples.

### BRIEF DESCRIPTION OF THE DRAWINGS

Embodiments of the invention will now be described, by way of example only, with reference to the attached drawings, in which:

FIG. 1. a process of making flange carried out right in the steel mill;

FIG. 2 another process of making flange by using rolling mill with impressed form;

FIG. 3 is another process of making flange by Fine Blanking;

FIG. 4 is the process of making hole saw back plate by fine blanking;

FIG. 5. is a section view of an embodiment of a flange assembly with the flange made by Fine Blanking;

FIG. 6 is a section view of a further embodiment of the flange assembly, wherein a catalytic converter is included;

FIG. 7 is a section view of the catalytic converter.

### DETAILED DESCRIPTION OF THE INVENTION

### Flange Making Process

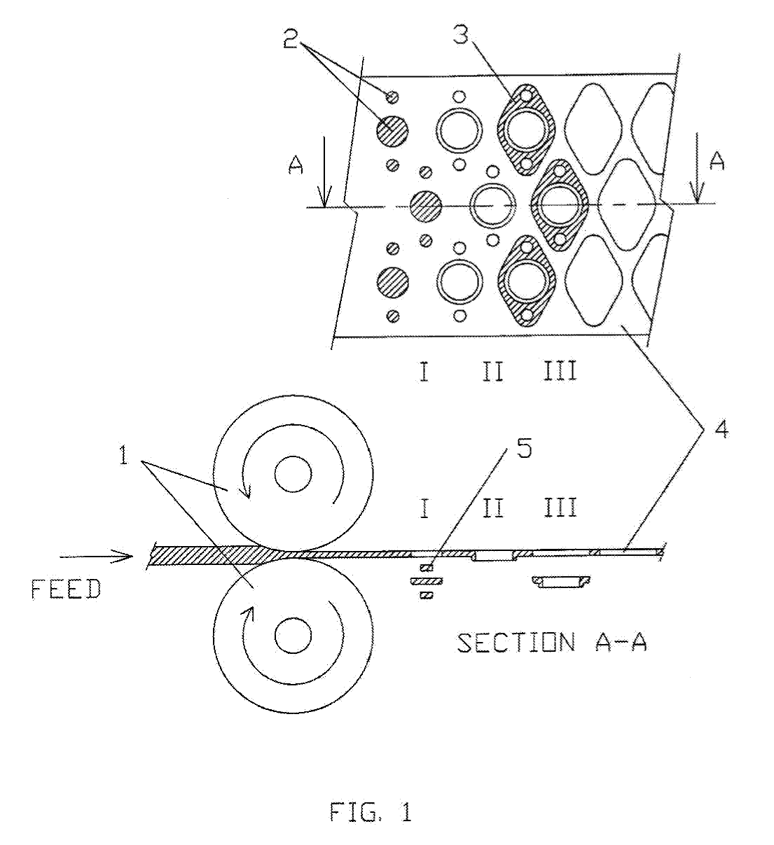

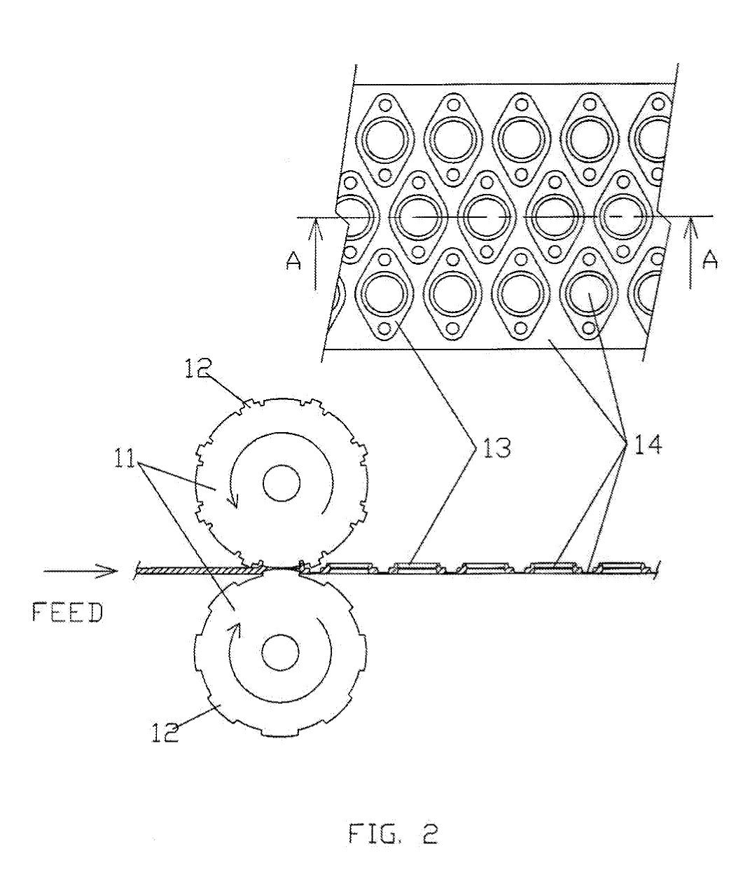

The first embodiment of this invention is a flange making process, which is carried out right at the steel mill (FIG. 1). The hot sheet metal coming out of the final sizing rolling mill 1 is processed through synchronized press operations like punching (station I), protruding collar through lancing (station II) and blanking (station III). The temperature of the hot sheet metal out of the rolling mill could be around 1000° C.

The non-used blanks/cut-offs are recycled directly into the melting furnace. The almost finished blanks 3 will be processed for finish machining right in the steel mill or in an ancillary plant in close vicinity.

Because the sheet metal coming right from the hot rolling mill is still hot, the synchronized press can be easier and the hot non-used blanks/cut-offs can be recycled directly into the melting furnace. It makes the process low cost, energy-efficient and environmental-friendly.

Yet another embodiment of the invention is a process that uses rolling mill 11 with impression forms 12 to press flange forms in hot metal sheet. These flange forms will be connected by thin flash web and slugs 14 and will be punched out at a synchronized press station (not shown). The synchronized press station could be a punching station. Because of the flash web is thin, it could save energy on the punching process and also save the material and improve the productivity.

This process can also raise protruded collars around the middle hole and stiffening ribs on the flange form 13 by changing the impression forms on the rolling mill.

The minimal amount of scraps in shape of thin flash web and slugs can also be recycled back to melting furnace.

Again the almost finished blanks 3 could be processed for finish machining right in the steel mill or in an ancillary plant in close vicinity.

The rolling mill 11 could be the only rolling mill for hot rolling. It also could be one of the rolling mill for hot rolling, which is the last rolling mill of the hot rolling process.

To save the material, the thickness of the flash web and slugs could be as thin as possible. It could be around 5 mm or less than 5 mm. The flash web and slugs could be around the central holes and the surrounding of each flanges body.

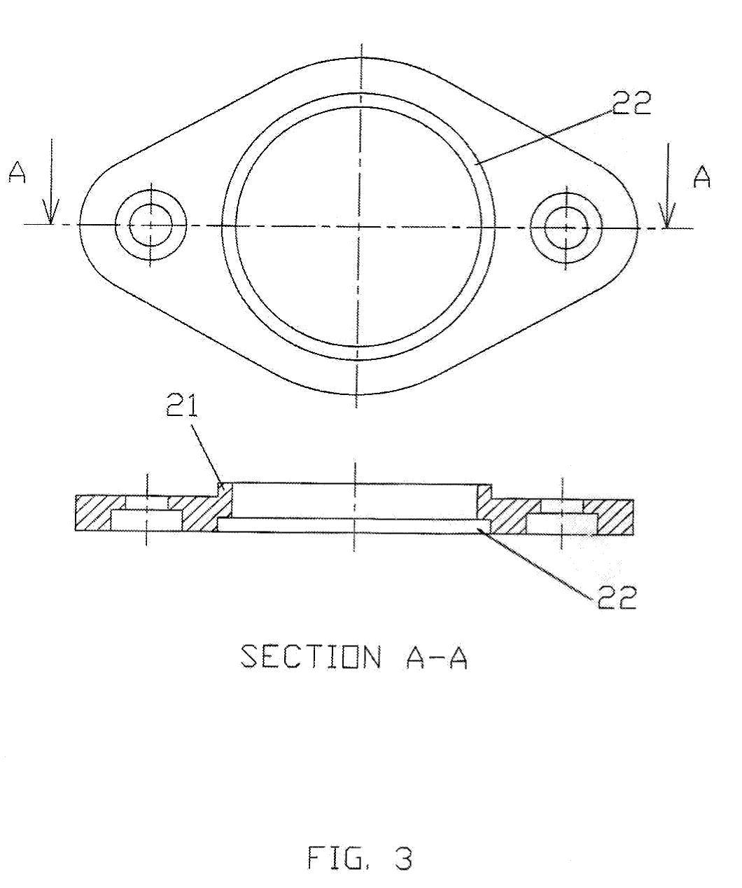

The third embodiment of this invention is the process of making flange by Fine Blanking (FIG. 3). This process involves shaping flanges out of sheet metal in cold state by fine blanking process.). The process includes synchronized press operations like punching (station I), protruding collar through lancing (station II) and blanking (station III). The biggest advantage is that many features like counter bores 22 and protrusions 21 can be finished in the fine blanking press eliminating expensive machining. Also the openings will be finished with close tolerances and good finish without any need of machining.

The Fine blanking process can form protrusion 21 around the central hole on the rear surface and a counter bores 22 on the front end surface. The front end surface is the mating face that connected to another flange. The flanges could be made by lancing process to form a protrusion and a semi counter bore with radius.

The protrusion 21 could have a thickness of 1-1.5 times of the thickness of the tube it is assembled to. It can reduce the disparity for welding purpose. It requires low heat weld of tube and flange. Moreover, it moves the heat zone much further from the mating surface of flange hence minimizing any deforming and leakage.

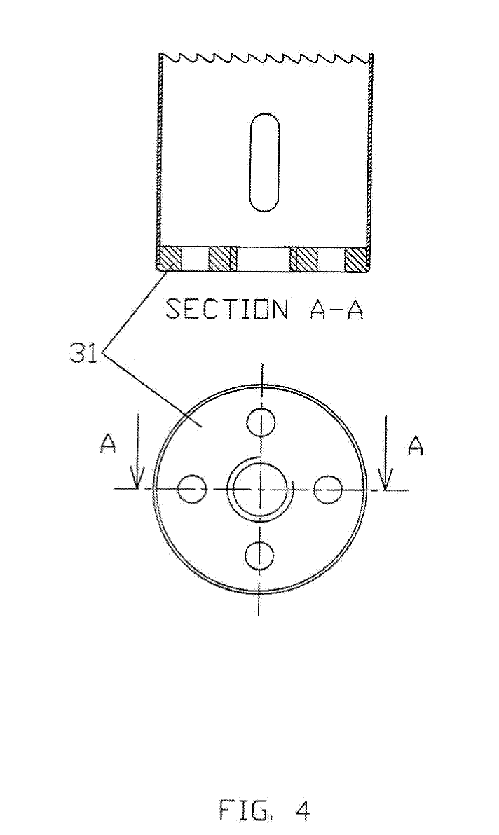

This Fine Blanking process will facilitate the use of the center slug for the stamping of parts such as: Back plate 31 for Hole Saws (FIG. 4), smaller pulleys, etc.

Flange Assembly with Flange Made by Above Process

The flanges made by fine blanking process as described above have the benefit of moving welding away from the sealing surface, therefore decreasing the deformation and leakage. But it also has the drawback. To protrude the maternal, a cavity or a counter bore is created on the sealing surface of the exhaust assembly. This creates non-favorable, eddy currents and also creates a pocket for water condensation promoting early start of corrosion. To overcome the drawback, a flange assembly is provided in this invention.

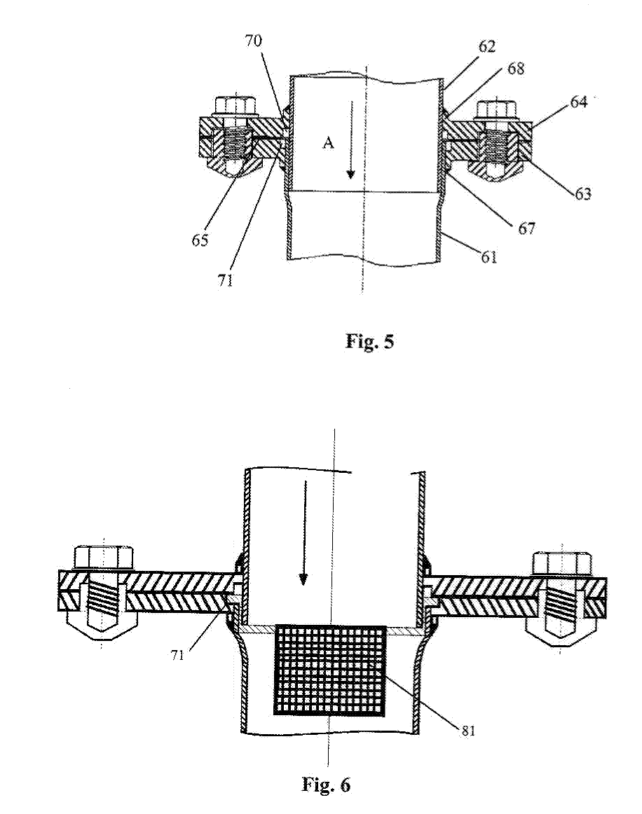

A flange assembly is provided as shown in FIG. 5. The flange assembly comprising: first flange 63 and second flange 64 for respectively receiving ends of first tube 61 and second tube 62 to be joined, said flanges 63 and 64 being securable to each other to join said tubes 61 and 62, said flanges 63 and 64, when abutted against each other, having at least two opposing holes therethrough, and fastening means positionable through said opposing holes to secure said flanges to each other.

As in FIG. 5, arrow A shows the direction of flow of hot gases through flange assembly. The first Flange 63 joined to first tube 61 through weld 67 is a subassembly element of the muffler side. The second flange 64 joined to tube 62 through weld 68 forms a subassembly element of the engine/motor side. The first flange 63 is disposed on the end of the first pipe 61 and the second flange 64 is disposed in a position retracing a predetermined length to the end of the second pipe 62. The protruding section on the end of the pipe second 62 extends from the second flange 64 to the end of the first pipe 61. Therefore, the joined faces of both first flange 63 and second flange 64 are covered by the inner circumference of the protruding section of the first second pipe 62.

In this example, the end of the first tube 61 is expanded, and the second tube 62 is extended through the second flange 64 for a close fit into the expanded portion of first tube 61. It also could be the second tube 62 is shrink to be able to fit in the first tube.

It is preferred that the first pipe is in a downstream side and the second pipe is in an upstream side, but of course the opposite could also work.

This design offers following advantages: the rings or counter bores 70 and 71 created by fine blanking operation on both flanges are shielded by protruding section of the second tube 62, which can avoid undesirable eddy currents; the protruding section of the second tube 62 also helps in reducing leakage of gases through the mate surface; the overlapping tubes arrangement also avoids gaps for condensation in flange joint area.

Optionally, one or two overlapping gaskets (not shown) in the ring or counter bores 70 can be included in the assembly. Even if the joint might lose some of its stretch, there is no leaking from the joint.

The flange assembly is illustrated by the flange made by fine blanking process, which has a counter bores 22 and protrusions 21 as shown in FIG. 3. It also could be used for the flanges without the protrusions 21 or counter bores 22.

In a further embodiment shown in FIG. 6, a catalytic convert 81 can also be included in the assembly. The catalytic converter 81 is attached on the ring or counter bores 71 (undercut). It can serves as a sealing as well as additional air purification when the primary catalytic converter in the exhaust system does not perform 100%.

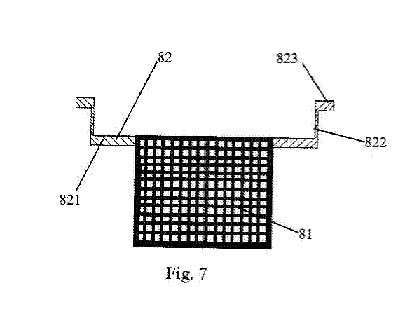

One example of the catalytic converter with install frame is shown in FIG. 7, wherein the catalytic converter 81 is a cylinder shaped chamber filled with catalyst carrier or substrate and catalyst itself. The catalyst could be any normal catalyst that converts toxic pollutants in exhaust gas to less toxic pollutants by catalyzing redox reactions (oxidation or reduction). Persons skilled in the art can easily choose proper catalyst according to requirements. The install frame 82 could include a bottom 821, side 822 and a ring-shaped flange 823. The catalytic converter 81 is attached to the bottom 821 and the bottom 821 could be a ring-shaped plate. The side 822 could be cylinder-shaped that fit in the gap between first and second tubes of the overlap portion, the ring-shaped flange 823 sits in the ring or counter bores 71 of the second flange. Optionally, the cross-section of the ring-shaped flange 823 is same to the cross-section of the ring or counter bores 71, therefore the ring shaped flange 823 could serve as a sealing or gasket for the ring or counter bores 71.

In case of a recall, likes Volkswagen Car company had to do in 2005 to reducing emission, they had to add small catalytic converter to the exhaust system. But there is no room on the outside exhaust system. So a miniature catalytic convector stack inside this flange joint will help in reducing emission.

Since the catalytic converter is installed in the flange assembly, it is easy to be changed whenever it is necessary. On the other hand, the installation of the catalytic converter can also enhance the sealing of the joint.

This flange assembly with the catalytic converter could be used on the exhaust system of the two-wheelers or three-wheelers in developing countries, such as India and China.

It will be evident to those knowledgeable in the field of the invention that many variations on the example(s) described above are conceivable within the scope of the invention. It should therefore be understood that the claims which define the invention are not restricted to the specific examples(s) described above. Possible variations include, for example, the flange assembly can also be used with any flange, for example the flanges that does not has the counter bore/cavity but has protrusion. Method of the manufactures can be stamping, fine blanking, hole flanging, lancing and so on.

1. A flange making process, which including the synchronized press to process the sheet metal right coming out of hot rolling mill.

2. A flange making process of claim 1, wherein the non-used blanks or cut-offs from synchronized press are recycled directly into the melting furnace.

3. A flange making process of claim 1, wherein the synchronized press operation includes punching.

4. A flange making process of claim 1, wherein the hot rolling mill has impression forms to press flange forms on metal sheet.

5. A flange making process of claim 4, wherein the synchronized press operations including punching, lancing to form protruding collar on flange.

6. A flange assembly, which comprising first flange and second flange for respectively receiving ends of first tube and second tube to be joined, said flanges being securable to each other to join said tubes, wherein the second tube is extended through the second flange and into the first tube.

7. A flange assembly as in claim 6, wherein the second pipe is in the upstream side and the first pipe is in the downstream side.

8. A flange assembly as in claim 6, wherein the flanges are made by fine blanking process to form a protrusion and a counter bore.

9. A flange assembly as in claim 8, wherein the flanges are made by lancing process to form a protrusion and a semi counter bore with radius.

10. A flange assembly as in claim 8, wherein one or two overlapping gasket is included in the counter bore.

11. A flange assembly as in claim 6, wherein a catalytic converter is attached to the assembly.

12. A flange assembly as in claim 6, wherein a miniature catalystic converter is attached to the [symbol]
